(19) United States
(12) Patent Application Publication
(10) Pub. No.: US 2016/0376817 A1
(43) Pub. Date: Dec. 29, 2016

(54) MOTOR VEHICLE DOOR LOCK

(71) Applicant: KIEKERT AG, Heiligenhaus (DE)

(72) Inventor: Michael Strathmann, Velbert (DE)

(21) Appl. No.: 15/039,892

(22) PCT Filed: Oct. 2, 2014
(86) PCT No.: PCT/DE2014/100348

§ 371 Date: May 27, 2016

(30) Foreign Application Priority Data
Nov. 30, 2013 (DE) 10 2013 017 960.2

(51) Int. Cl. E05B 77/38; E05B 85/26; E05B 15/16; E05B 77/40

(52) U.S. Cl. CPC E05B 77/38; E05B 77/40; E05B 85/26; E05B 15/1635; E05B 2015/165

(57) ABSTRACT

The invention relates to a motor vehicle door lock which is provided with at least one locking mechanism (1, 2) consisting essentially of a rotary latch (1) and a detent pawl (2), and with at least one stop (4) for the locking mechanism (1, 2), the stop being permanently attached to the housing. The stop (4) interacts with a plastic protuberance (6) on the rotary latch (1) or detent pawl (2). According to the invention, the protuberance (6) and the stop (4) are made from different plastics, or from plastics with different degrees of hardness.

The invention relates to a motor vehicle door latch which is provided with at least one locking mechanism consisting essentially of a catch and a pawl and at least one stop for the locking mechanism, the stop being permanently attached to the housing, with the stop interacting with a plastic protuberance on the catch and/or the pawl.

Different approaches are used to minimize noise in motor vehicle door latches. Generally, the catch is covered by plastic in order to reduce “metal sounds” during closing and opening of the locking mechanism to a minimum. In addition, numerous other approaches are used, i.e. a brake block is used in the generic prior art disclosed in DE 10 2005 007 433 A1. In addition to the brake block ensuring low-noise braking of the catch in the overtravel range when it makes contact with the end stop, also a buffer stop is provided for reducing the impact during closing.

For this purpose the catch contains a buffer bag which is assigned to said buffer stop in closing direction of the catch, in order to reduce the impact. The buffer bag is provided as a slot in a plastic cover of the catch. In addition, a protuberance cooperates with the buffer stop, said protuberance being arranged in the main ratchet position of the catch between the buffer bag and the buffer stop. This already ensures a particularly low/noise operation and an effective sound damping, in particularly during closing of the known locking mechanism.

The prior art is, however, not satisfactory in all aspects. This is due to the fact that in addition to metal closing noises, effectively dampened by the known solution, bouncing noises are increasingly experienced in practical application, caused by vibrating movements of the catch during closing. Such motor vehicle door vibrations can occur during mechanical closing and also where closing is assisted by a closing aid.

Essentially, the bouncing is caused by the fact that during the closing of the locking mechanism, the consequently closed catch produces a hard metal impact on the pawl with considerable speed and thus closing energy, allowing the catch to visibly bounce back, in particular as any elasticity, such as a rubber door seal, permits such movements. In practical applications, movements of the catch during closing and in particular upon reaching the main-ratchet position occur in the direction of the pawl from where they bounce back and then return in the direction of the pawl again. This generates said bouncing. The described bouncing operation can potentially generate unwanted bouncing noises in addition to metal closing noises. The invention aims to remedy this.

The invention is based on the technical problem of further developing said motor vehicle door latch in such a way that the dampening of noises during closing is improved further compared to the prior art and that bouncing is, in particular, avoided or at least suppressed.

In order to solve this technical problem, the invention suggests that the protuberance and stop in a generic motor vehicle door latch are made from different plastic or plastic with different hardness. In other words, the protuberance and the stop are made from plastic. The invention uses, however, different types of plastic, i.e. types of plastic differing in elasticity and hardness.

In this context it has actually proven to be advantageous for protuberance to be a soft and the stop to be a hard component. In this context, the hard plastic component of the stop typically has a Shore D hardness of 40 to 80 and preferably 50 to 65. It is known that the Shore D hardness of plastic is determined by usually pushing a test body in form of a steel pin onto the respective plastic or its surface using the force of a spring. The method for determining the Shore D hardness generally uses a spring preloaded to 0.55 N.

In contrast, the method for measuring Shore A hardness uses a steel pin without spring load. The Shore hardness is determined from the depth of penetration of the steel pin in the material.

For the hard component and thus the stop, the invention recommends the use of plastic such as polyester (PES) or polycarbonate (PC). A possible material has the brand name Hytrel® and is produced by DuPont. The Shore D hardness of these materials lies in the range of between 50 to 65.

The soft component and thus the protuberance has a Shore A hardness of less than 80 and, in particular, of less than 70. Preferably the Shore A hardness is less than 60.

Examples for suitable materials are elastomers, such as ethylyne-acrylate-caoutchouc (EA) or also fluoro silicon cautchouc (MFQ). In principle, other elastomers can naturally also be used, provided that their Shore A hardness is regularly lower than 80 and, in particular lower than 70. Particularly preferred is the use of soft components having a Shore A hardness of less than 60.

The particularly “soft” design of the soft component or of the protuberance takes into account that the respective protuberance generally interacts with the stop in such a way that the protuberance engages in a recess on or in the stop. The stop does actually regularly contain such a recess for the protuberance. In this context the protuberance, advantageously designed as a soft component, has the shape of a brake block, accommodated in the recess of the stop as a hard component and nestling in the recess. As a result, the locking mechanism is not only slowed down when the protuberance enters the recess but is also retained so that said bouncing or associated bouncing movements do no longer or nearly no longer occur.

This is due to the fact that the interaction between the protuberance regularly designed as a soft component on one hand and the stop designed as a hard component on the other hand, does not only ensure that the slight relative movements between the locking mechanism and the stop are permitted and compensated for. But also, the locking mechanism generally remains in its closed position as a result of the interaction between the protuberance and the stop or the recess accommodating the protuberance.

In most cases, the protuberance is provided on the catch. Also, the described interaction between the protuberance and the stop or the recess assigned to the stop generally occurs in the main-ratchet position of the catch, so that the aforementioned bouncing can not or practically no longer occur. This is due to the fact that the pivot movements of the catch around its axis of rotation associated with bouncing in the prior art, are suppressed in the described main-ratchet position by the brake block or the protuberance engaging in the recess.

It has proven to be advantageous for the protuberance to be detachably connected to the catch and/or the pawl. As a result, the catch and pawl on one hand and the protuberance on the other hand can be separately produced and from different material. This is regularly the case, as the catch and the pawl are generally metal parts and, in particular, punched steel parts, whilst the protuberance is made from plastic.

In this context it has proven to be particularly advantageous for the protuberance to be designed as a plastic tab. The already mentioned detachable connection between the protuberance on one hand and the catch or pawl on the other hand, can typically be provided and implemented by a plug-in connection. Generally, also a snap connection, a bolted connection or other detachable connections are feasible for coupling the protuberance on one hand and the catch or pawl on the other hand.

The scope of the invention also includes, however, fixed coupling of the protuberance to the catch. It is, for instance, feasible for the protuberance and the catch or pawl to be adhesively connected to each other. The protuberance can also form a single piece together with the catch and/or pawl. In this case, the catch or pawl can be clad with a plastic cover, not only covering the catch or pawl but also serving to provide the protuberance formed on the catch or pawl.

In order to be able to particularly effectively retain the catch or locking mechanism in the described main ratchet position, the protuberance typically projects from the circumference of the catch. In most cases, the protuberance can be found in the area of a catch tab or can replace said tab. The stop including the respective recess is typically formed in or on a housing of the motor vehicle door latch and is thus fixed to the housing. In most cases a housing cover is used that is anyway produced from a (hard) plastic, for instance, polyester or polycarbonate, the aforementioned types of plastic suitable for providing the hard component or stop. Consequently, the stop can form a single piece together with the housing or regularly a housing cover.

The invention is based on the knowledge that the catch and the pawl or the locking mechanism are mounted in a metal frame box, covered by the housing or said housing cover. For this purpose, the respective housing cover generally extends above the frame box. The stop can thus be easily defined on the housing cover and thus protrudes into the frame box in order to be able to interact with the protuberance on the catch or the pawl. The housing or the housing cover is generally produced as part of a plastic injection molding process.

An object of the invention is also a method for producing a motor vehicle door latch in which the protuberance on one hand and the stop on the other hand are produced from a different plastic type or plastic hardness. In any case, the described clamping of the catch or pawl regularly ensures in the main-ratchet position that the locking mechanism is fixed. This considerably or completely reduces any bouncing movements experienced in prior art embodiments. Also, the catch moves against the pawl in the described main-ratchet position at considerably lower speed than in prior art embodiments.

Essentially this is due to the fact that the protuberance made from soft plastic or the soft component is increasingly immersed in the recess of the hard component or of the stop in the main-ratchet position and is retained therein. This results in a quieter closing noise.—Lastly, it should be emphasized that the interaction between the protuberance and the stop is naturally not (only) limited to the main ratchet position of the locking mechanism but can also become alternatively or additionally effective in the pre-ratchet position or overtravel position of the locking mechanism. These are the main advantages of the invention.

Below, the invention is explained in more detail with reference to a drawing showing only one embodiment, in which:

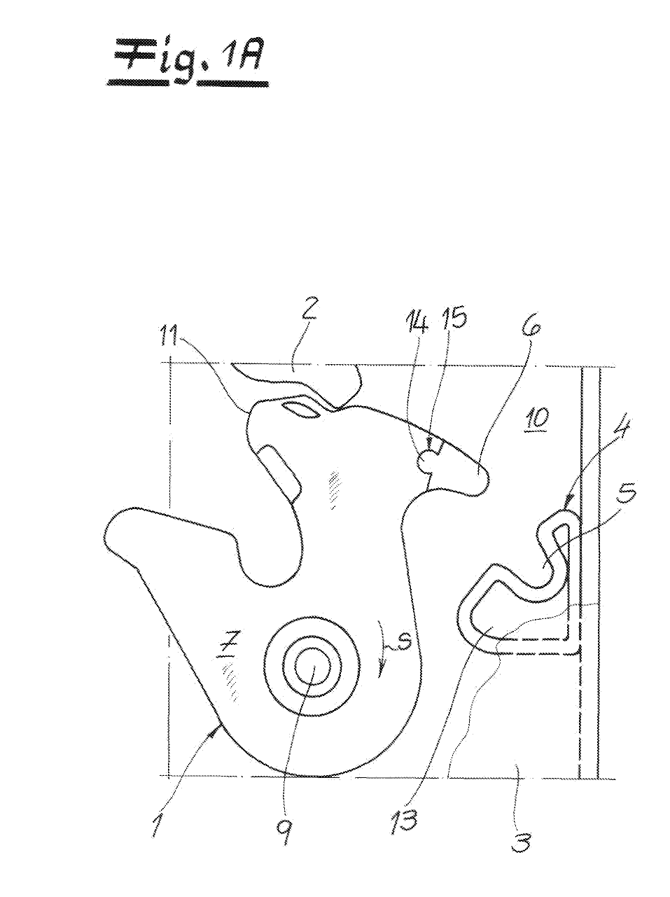

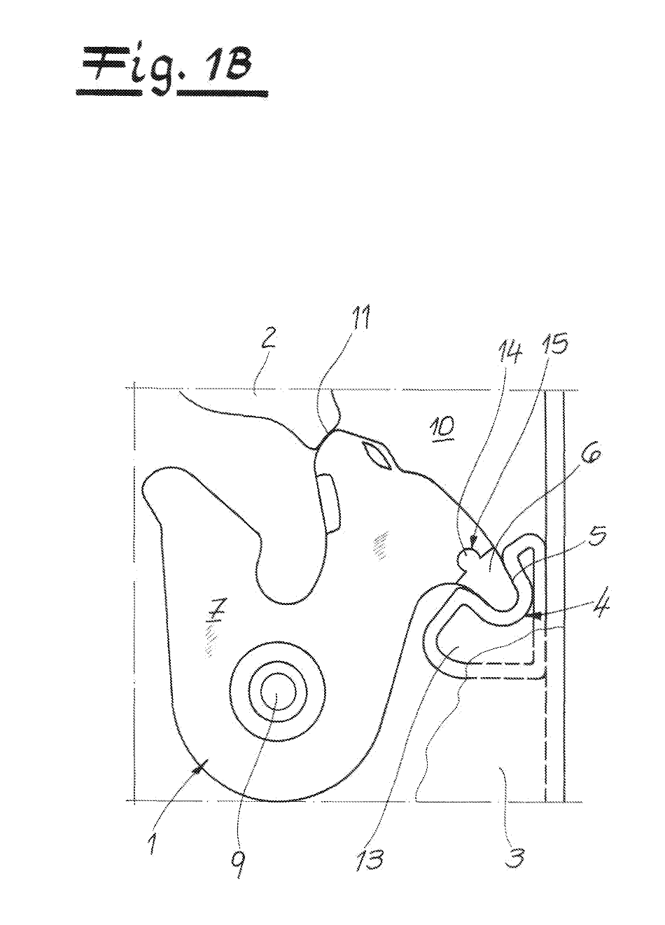

FIG. 1A and 1B show the motor vehicle door latch of the invention in a first embodiment in different functional positions and

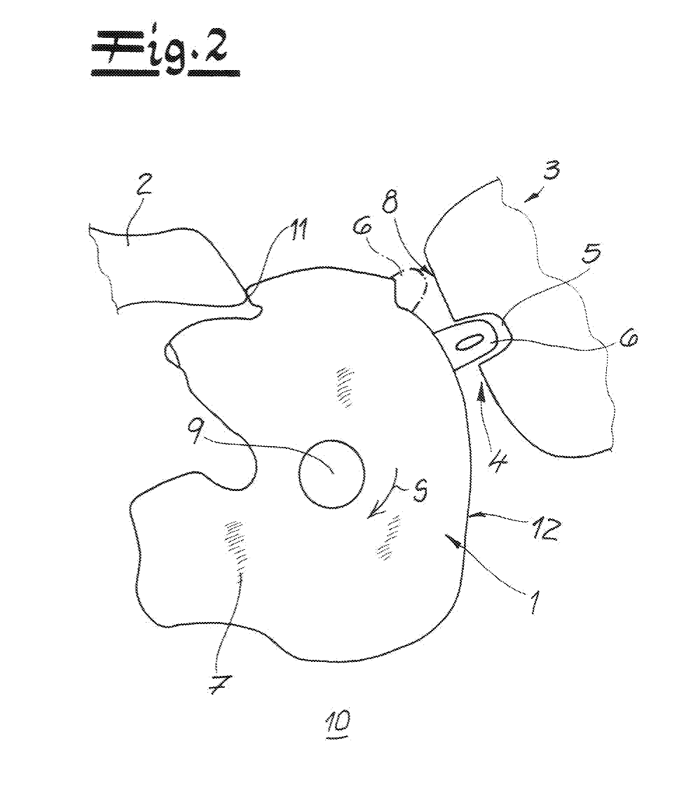

FIG. 2 shows a modified embodiment.

The figures show a motor vehicle door latch with only details of a locking mechanism 1, 2. Apart from the locking mechanism 1, 2, only a housing 3 is at least partially shown. The housing 3 is generally a plastic housing or a plastic housing cover 3. The locking mechanism 1, 2 is, on the other hand, mounted in an unspecified frame box 10.

The frame box 10 is manufactured from metal, in particular, steel and may have a U-shaped cross section. The plastic housing or the plastic housing cover 3 essentially extends parallel to a main plane of the frame box 10, as indicated in FIG. 1A. This figure shows that the plastic housing cover 3 is arranged above the frame box 10, when viewed from the top.

As usual, the locking mechanism 1, 2 essentially comprises a catch 1 and a pawl 2. The locking mechanism 1, 2 is shown in the functional position of FIG. 1A in its opened or pre-ratchet position, whilst the functional position of FIG. 1B corresponds to the main-ratchet position of the locking mechanism 1, 2. This is naturally only an example and the invention is not limited to this.

The figures also show a stop 4 attached to the housing for locking mechanism 1, 2. The respective stop 4 is formed in the housing 3 or in a housing part, formed in this case on the plastic housing cover 3. This means that the plastic housing cover 3 on one hand and the stop 4 on the other hand form a single-piece component in the embodiment being or having been produced by plastic injection molding.

As soon as the locking mechanism 1, 2 assumes its main-ratchet position shown in FIG. 1B, said stop 4 interacts with a protuberance 6 on the catch 1. In principle, the protuberance 6 can alternatively or additionally also be shaped or formed on the pawl 2, which is, however, not shown. The catch 1 can also contain a plastic cover 7.

As part of this application and according to the invention, the protuberance 6 and also the stop 4 are each manufactured from plastic. Types of plastic with different hardnesses are used, as already described above. The protuberance 6 is actually a soft component with a Short A hardness of less than 60. In contrast, stop 4 is a hard component made from plastic with a Short D hardness of 40 to 80.

It is apparent that the protuberance 6 is designed as a brake block 6 in the embodiments. The protuberance or the brake block 6 engages in a recess 5 of stop 4 in the main-ratchet position of the locking mechanism 1, 2. In the embodiment shown in FIGS. 1A and 1B, the stop 4 is essentially triangular when viewed from the top. The stop 4 is also a web arrangement surrounding a free space 13. The recess 5 is integrated in the web arrangement.

In contrast, stop 4 of the embodiment, as shown in FIG. 2, is solid and the recess 5 is defined in this solid plastic part. On the side of the recess 5 also an inlet ramp 8 is provided. The inlet ramp 8 moves ahead of the recess 5 in the closing direction S of catch 1.

The catch 1 is mounted in the respective frame box 10 and is rotatable around an axis 9. In order to move the catch 1 or the locking mechanism 1, 2 in the main-ratchet position shown in FIGS. 1B and 2, the catch 1 is then pivoted in clockwise direction or the closing direction S until the pawl 2 engages and can also engage in a main-ratchet recess 11 of the catch 1. The starting position of the catch 1 during this closing operation is indicated in FIG. 1 as well as by the dashed-dotted lines in FIG. 2.

As the plastic brake block 6 or protuberance 6 is produced from a soft component and thus from a soft elastomer with the said Shore A hardness, the protuberance or brake block 6 is guided during the respective closing process in closing direction S in the embodiment of FIG. 2 along the inlet ramp 8 and is increasingly compressed. This is due to the fact that the protuberance 6 projects radially from a circumference 12 of the catch 1, as also apparent from FIGS. 1A and 1B of the example.

As soon as the brake pad or the protuberance 6 in the embodiment shown in FIG. 2 enters the area of the inlet ramp 8, the inlet ramp 8 ensures that the protuberance 6 is increasingly compressed. The inlet ramp 8 not only precedes the recess 5 in closing direction S but also forms an almost tapered slot together with the circumference 12 of the catch 1. This causes the protuberance 6 to be compressed with the aid of the inlet ramp 8, as described, only expanding upon reaching the recess 5 in stop 4.

In the embodiment shown in FIGS. 1A and 1B there is no or hardly any deformation of the protuberance 6 made from elastomer plastic. In this case, too, the protuberance 6 in the main-ratchet position of the locking mechanism 1, 2, as shown in the functional drawing in FIG. 1B, engages fully or nearly fully in recess 5.

It is also apparent from comparing FIGS. 1A and 1B that the protuberance 6 is detachably connected to catch 1. In general, also the pawl 2 can contain a detachably connected protuberance 6, although this is not shown.

In the embodiment, the protuberance 6 is a plastic tab 6 or the brake block 6 already described. The protuberance 6 or the plastic tab is connected to the catch 1 by means of a plug-in connection 14, 15. In the example, the plug-in connection 14, 15 consists of a circular plug-in tab 14 and a complementing circular plug-in recess 15. In place of the plug-in connection 14, 15, also a snap connection, a bolted connection or another detachable connection can be provided between the protuberance 6 and the catch 1 or the pawl 2.

Alternatively, the protuberance 6 can also form a single piece with the catch 1 and/or pawl 2. This is shown in the embodiment of FIG. 2 in which the protuberance 6 is or can be part of the plastic cover 7.

In any case, the recess 5 on one hand and the protuberance or the brake block 6 on the other hand are adapted to each other in from and shape. As a result, the catch 1 is locked opposite the housing 3 or the plastic housing cover 3 in the main-ratchet position of the locking mechanism 1, 2. This is due to the fact that in the main-ratchet position, the protuberance 6 and the recess 5 operate like a detent mechanism with latch cam 6 and latch recess 5. This effectively suppresses any pivoting or swinging movement of the catch 1 around its axis. In this way, the bouncing between the catch 1 and the pawl 2 experienced in the prior art, does not (no longer) occur.

1. A motor vehicle door latch with at least one locking mechanism consisting essentially of a catch and pawl and with at least one stop for the locking mechanism, the stop being permanently attached to the housing in which the stop interacts with a plastic protuberance on the catch and/or of the pawl, wherein the protuberance and the stop are made from different plastics.

2. The motor vehicle door latch according to claim 1, wherein the protuberance is a soft component and the stop a hard component.

3. The motor vehicle door latch according to claim 2, wherein the hard component has a Shore-D hardness of 40 to 80 and, in particular 50 to 65.

4. The motor vehicle door latch according to claim 2, wherein the soft component has a Shore-A hardness of less than 80, in particular less than 70 and preferably of less than 60.

5. The motor vehicle door latch according to claim 1, wherein the protuberance is detachably connected to the catch and/or the pawl.

6. The motor vehicle door latch according to claim 1, wherein the protuberance is a plastic tab.

7. The motor vehicle door latch according to claim 1, wherein the protuberance is connected to the catch and/or pawl by means of a plug-in connection, a snap connection, a bolted connection, etc.

8. The motor vehicle door latch according to claim 1, wherein the protuberance is designed to form a single piece with the catch and/or pawl.

9. The motor vehicle door latch according to claim 1, wherein the stop contains a recess for the protuberance.

10. A method for the production of a motor vehicle door latch with at least one locking mechanism consisting essentially of a catch and pawl and with at least one stop for the locking mechanism, the stop being permanently attached to the housing in which the stop interacts with a plastic protuberance on the catch and/or of the pawl, wherein the protuberance and the stop are made from different plastics.
